(19) United States
(12) Patent Application Publication
(10) Pub. No.: US 2014/0305271 A1
(43) Pub. Date: Oct. 16, 2014

(54) PAPER PUNCH WITH ADJUSTABLE PUNCH SEATS

(71) Applicant: PAO SHEN ENTERPRISES CO., LTD., Chang Hua County (TW)

(72) Inventor: Tsung-Wen HUANG, Chang Hua County (TW)

(73) Assignee: PAO SHEN ENTERPRISES CO., LTD., Chang Hua County (TW)

(21) Appl. No.: 14/066,981

(22) Filed: Oct. 30, 2013

(30) Foreign Application Priority Data
Apr. 11, 2013 (TW) 102206543

(51) Int. Cl. B26F 1/36

(52) U.S. Cl. CPC B26F 1/36
USPC 83/618

(57) ABSTRACT

A paper punch includes a base and a slide board is connected to the base. Multiple punch seats are located on the slide board and above the hole of the base. Each punch seat has a control member and a connection arm connected to the slide board. The control member is pivotably connected to the connection arm. The control member has an eccentric seat and an operation board. The eccentric seat is a cam and eccentrically connected to the connection arm. A first face is defined in the eccentric seat and located in opposite to the operation board. A second face is located adjacent to the first face. When switching the first face to the second face, the punch seat is movable along the slide board so as to obtain a desired distance between the punch seats.

### FIELD OF THE INVENTION

The present invention relates to a paper punch, and more particularly, to a paper punch with movable punch seats so as to adjust the distance between punch holes.

### BACKGROUND OF THE INVENTION

A conventional paper punch has fixed punch seats so that the punch heads are located at fixed positions and the punch holes punched through the sheets are not able to be adjusted. This fixed feature cannot satisfy the practical needs when organizing documents. As shown in FIG. 7, a punch holes adjustable device is developed and generally comprises multiple punch seats on an elongate base. The paper punch has a base 60 and an L-shaped slide board 61 is connected to the base 60. Distance indexes 62 are marked on the outside of the top of the curved portion of the slide board 61. The slide board 61 further has a slot 63. The punch seats 70 each have a frame 72 with a punch head 71 located therein. The frame 72 has a threaded hole which faces the slide board 61 so that a bolt 73 extends through the slot 63 of the slide board 61 and is connected to the threaded hole of the punch seat 70 horizontally. Therefore, the positions of the punch seat 70 can be adjusted according to the indexes 62.

When adjusting the punch seats 70, the positions of the punch seat 70 can be adjusted according to the indexes 62 by unscrewing the bolt 73 relative to the slide board 61 so as to move the punch seat 70 along the slot 63 of the slide board 61. However, the bolt 73 is too small and has to be threadedly connected to the threaded hole of the punch seat 70 so as to position the slide board 61, so that the bolt 73 can easily drop or lost during assembling.

When rotating the bolt 73, a tool is needed and the assembler has to operate the tool and this takes time especially when adjusting the punch seat 70.

The punch seat 70 is simply connected t to the slide board 61 by the bolt 73, and the underside of the frame 72 is in contact with the surface of the base 60. When punching holes through the sheets, the punch seat 70 is not firmly installed and may shift or shake.

The primary object of the present invention is to provide a paper punch having movable punch seats so as to adjust the distance between punch holes. The adjustment can be easily made without using extra tool.

Another object of the present invention is to provide a paper unit wherein the punch seat has an engaging end so as to be firmly positioned to the base.

### SUMMARY OF THE INVENTION

The present invention relates to a paper punch and comprises a base having a hole and an index area respective located on the front and rear ends of the base. An elongate slide board is connected to the base and located between the hole and the index area. The slide board has a connection side on an outside thereof. Multiple punch seats are connected to the slide board and each punch seat is located above the hole of the base. Each punch seat has a connection arm extending therefrom which is located above the index area. A passage is defined through the connection arm and an opening is defined in the underside of the connection arm. The slide board is inserted into the opening of the connection arm. Multiple control members are provided and each have an eccentric seat and an operation board which is connected on one side of the eccentric seat. The eccentric seat is a cam and eccentrically connected to the connection arm by a pin. A first face is defined in the eccentric seat and located in opposite to the operation board. A second face is a curved face and located close to the pin. The distance from the pin to the second face is shorter than the distance from the pin to the first face, so that when switching the first face and the second face, the first face contacts the connection side of the slide board to position the punch seat to the slide board, a gap is defined between the second face and the connection side to allow the punch seat to be movable along the slide board.

Preferably, the base has two support arms extending upward from two ends thereof. The slide board is connected between the two support arms. Preferably, the connection side of the slide board is an in inclined surface.

Preferably, the frame of each of the punch seats has a hook-shaped engaging end which is located corresponding to the hole of the base.

Preferably, the engaging end is slidably hooked to an inside of the hole of the base.

The advantages of the present invention are that the control member has an operation board and an eccentric seat which is eccentrically connected to the connection arm of the punch seat, and the eccentric seat has a first face and a second face. By operation to the operation board, when the eccentric seat is pivoted about the pin, the two respective distances of the first face and the second face relative to the connection side of the slide board, such that the punch seat is movable along the slide board to obtain the desired position. When the second face is pivoted toward the connection side of the slide board, a gap is defined between the second face and the connection side, so that the first face is separated from the connection side to allow the punch seat to be movable. Therefore, the user simply operates the operation board of the control member, without any extra tool assistance, the distances between the punch holes can be adjusted.

The eccentric seat is pivotable about the pin so that the first face is pivoted to contact the connection side of the slide board to adjust the punch seat. Because the first face and the connection side are contact in the way of face to face, so that the contact area is large enough and the eccentric seat is eccentrically pivoted so that the first face properly presses the connection side to provide firm positioning feature.

The control member has the operation board and the eccentric seat, and the control member is connected to the connection arm of the punch seat, so that the control member and the punch seat is pivotably connected to each other, no separated bolt as seen in the conventional paper punch and the separated bolt may be lost.

The connection arm of the punch seat is cooperated with a control member so that the punch seats can be replaced or added on the slide board to provide more flexibility of the adjustment of the punch seats.

The underside of the punch seat contacts the base and has an engaging end which hooks to the inside of the hole of the base, the arrangement is cooperated with the connection between the control member and the slide board, the punch seat is therefore firmly connected to the base.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the paper punch of the present invention;

FIG. 2 is an exploded view to show the paper punch of the present invention;

FIG. 3 is a perspective view to show the punch seat of the paper punch of the present invention;

FIG. 4 is a cross sectional view to show that the control member positions the punch seat of the present invention;

FIG. 5 is a cross sectional view to show that the control member releases the punch seat of the present invention;

FIG. 6 is a cross sectional view to show the operation of the control member of another embodiment of the present invention, and

FIG. 7 is a cross sectional view to show the conventional paper punch.

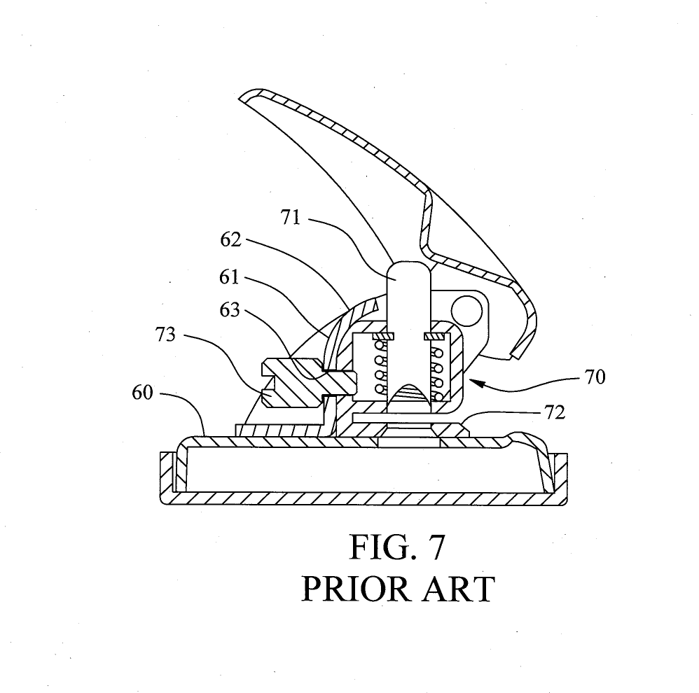

### DETAILED DESCRIPTION OF THE PREFERRED EMBODIMENT

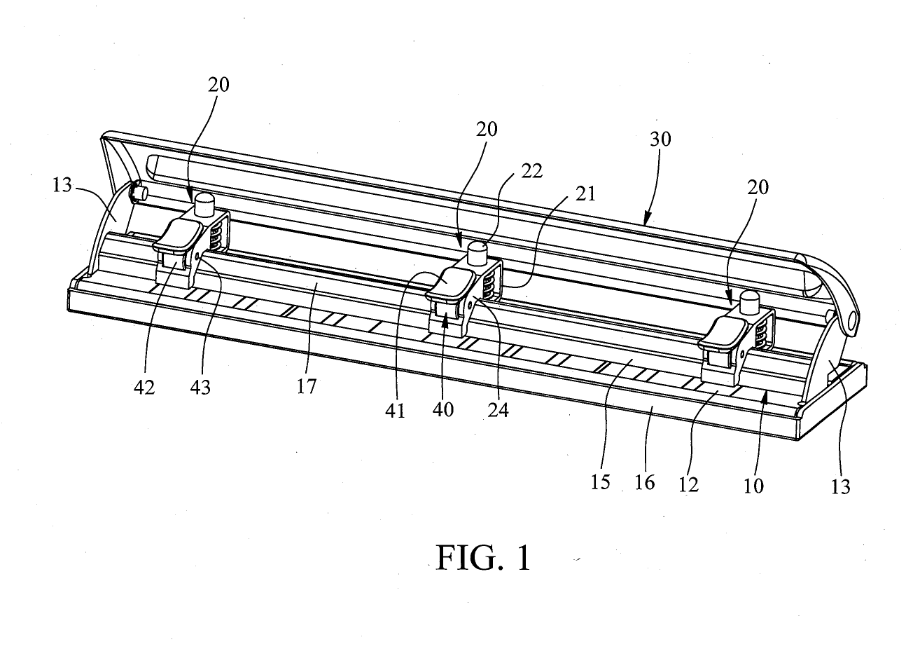

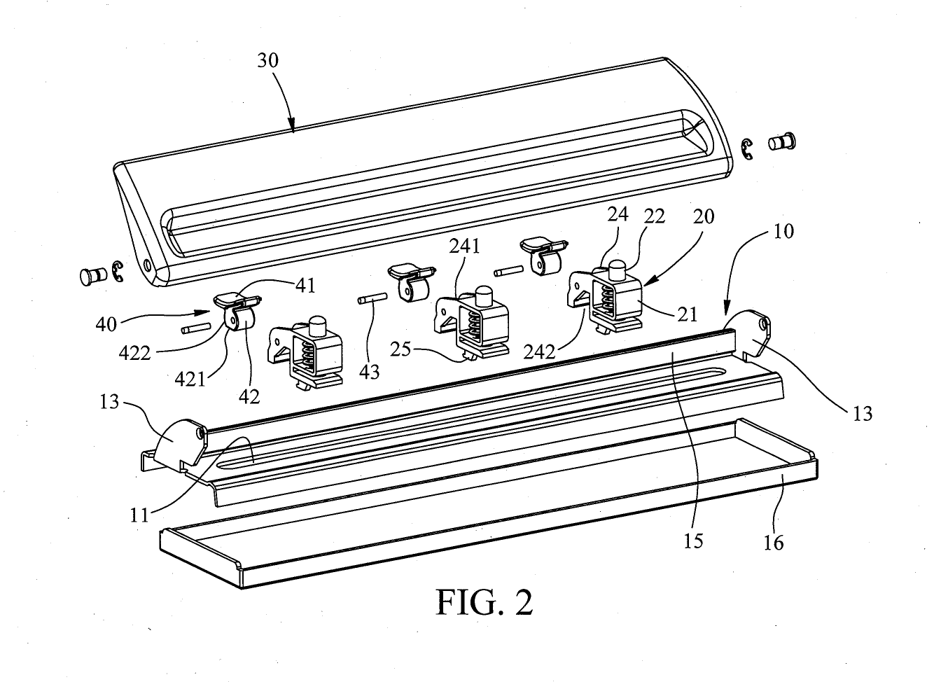

Referring to FIGS. 1 and 2, the paper punch of the present invention comprises a base 10, multiple punch seats 20 and a press board 30.

The base 10 has an elongate hole 11 defined in the front end thereof so that debris drop from the hole 11, and an index area 12 is formed on the rear end of the base 10. The base 10 has two support arms 13 extending upward from two ends thereof, and a slide board 15 is connected between the two support arms 13. A connection box 16 is installed to the underside of the base 10 to collect the debris from the hole 11. The press board 30 is pivotably connected to two respective top ends of the two support arms 13.

The multiple punch seats 20 are connected to the slide board 15 and located corresponding to the hole 11. Each punch seat 20 has a frame 21 and a punch head 22 which is installed to the frame 21 upright and able to return to its initial position by a spring. The punch head 22 punches holes through paper sheets. The frame 21 has an aperture 23 defined in the underside thereof and the aperture 23 is located corresponding to the hole 11. The punch head 22 movably extends through the aperture 23 when punching holes. The top end of the punch head 22 extends beyond the frame 21 and is pressed by the press board 30. The press board 30 pushes the punch head 22 downward to punch holes and the bouncing force of the punch head 22 pushes the press board 30 to its initial position when the punching action is completed.

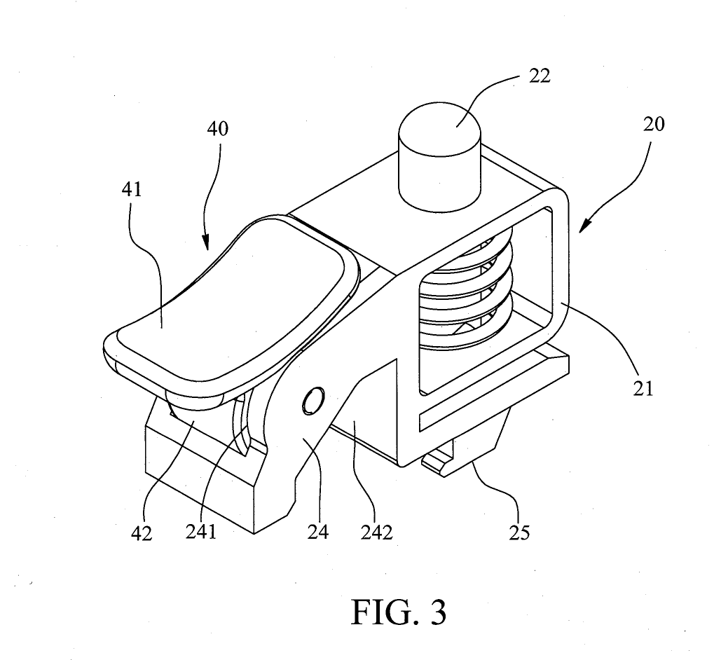

As shown in FIGS. 2 and 3, the slide board 15 having a connection side 17 on the outside thereof. A connection arm 24 extends from the punch seat 20 and is located above the index area 12. A passage 241 is defined through the connection arm 24 and an opening 242 is defined in the underside of the connection arm 24. The slide board 15 is located between the hole 11 and the index area 12, and the slide board 15 inserted into the opening 242 of each of the connection arms 24 as shown in FIG. 1.

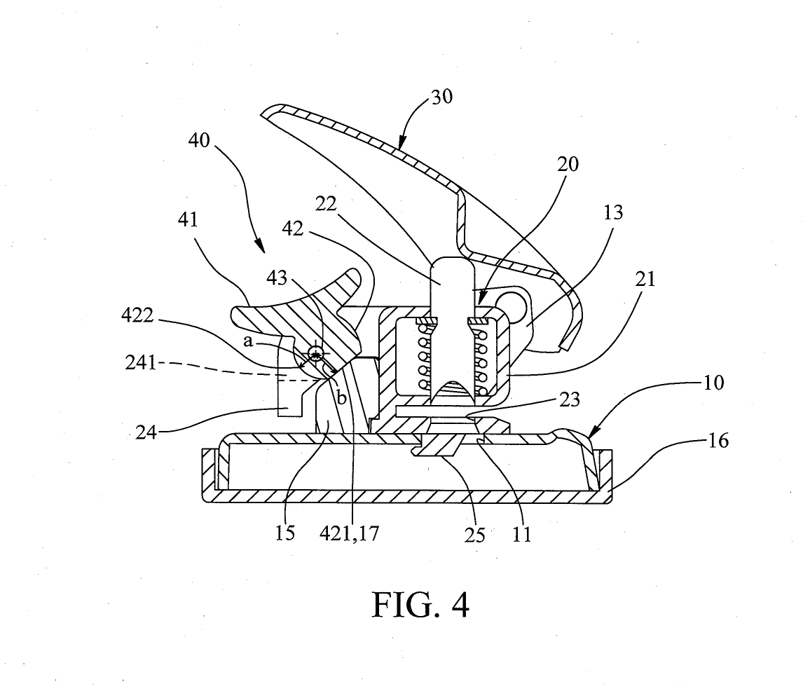

A control member 40 is connected to the passage 241 of each punch seat 20 and has an eccentric seat 42 and an operation board 41 which has a curved board so that the user can easily touch it. The eccentric seat 42 is a cam and eccentrically connected to the connection arm 24 by a pin 43 as shown in FIGS. 2 and 4, so that the eccentric seat 42 is pivotable about the pin 43. A planar first face 421 is defined in the eccentric seat 42 and located in opposite to the operation board 41. A second face 422 is a curved face and located close to the curved portion of the pin 43. The distance “a” from the pin 43 to the second face 422 is shorter than the distance “b” from the pin 43 to the first face 421. That is to say, the distance from the pin 43 to the second face 422 is shorter than the distance from the pin 43 to the first face 421, so that when pivoting the eccentric seat 42, the first face 421 contacts the connection side 17 of the slide board 15 to position the punch seat 20 to the slide board 15. On the contrary, when pivoting the eccentric seat 42 in opposite direction to let the second face 422 pivot toward the slide board 15, the second face 422 is gradually removed from the connection side 17 of the slide board 15 so that a gap is defied between the second face 422 and the connection side 17. The punch seat 20 is movable along the slide board 15.

The frame 21 of each of the punch seats 20 has a hook-shaped engaging end 25 which is located corresponding to the hole 11 of the base 10. The engaging end 25 is slidably hooked to the inside of the hole 11 of the base 10, so that the punch seat 20 is securely connected to the base 10 and is not separated from the base 10. The engaging end 25 and the punch seat 20 simultaneously slide board along the inside of the hole 11 of the base 10, so that the punch seat 20 is stably operated.

When the slide board 15 is connected to the punch seats 20, as shown in FIGS. 1, 4 and 5, the opening 22 of the punch seat 20 engages with the slide board 15, and the engaging end 25 is slidably hooked to the inside of the hole 11 of the base 10, so that the underside of the frame 21 is matched to the surface of the base 10. The engaging end 25 is slidably hooked to the inside of the hole 11 of the base 10, the punch seat 20 is stably operated. The punch seat 20 and the control member 40 are connected to the connection arm 24 so that the connection arm 24 can be slid according to the index of the index area 12 until the desired punching position. The operation board 41 is then operated to pivot the eccentric seat 42 about the pin 43 so that the first face 421 is pivoted toward the slide board 15 and presses the connection side 17, such that the punch seat 20 is positioned. Therefore, the punch seat 20 can be adjusted the distance along the slide board 15 without using any extra tool.

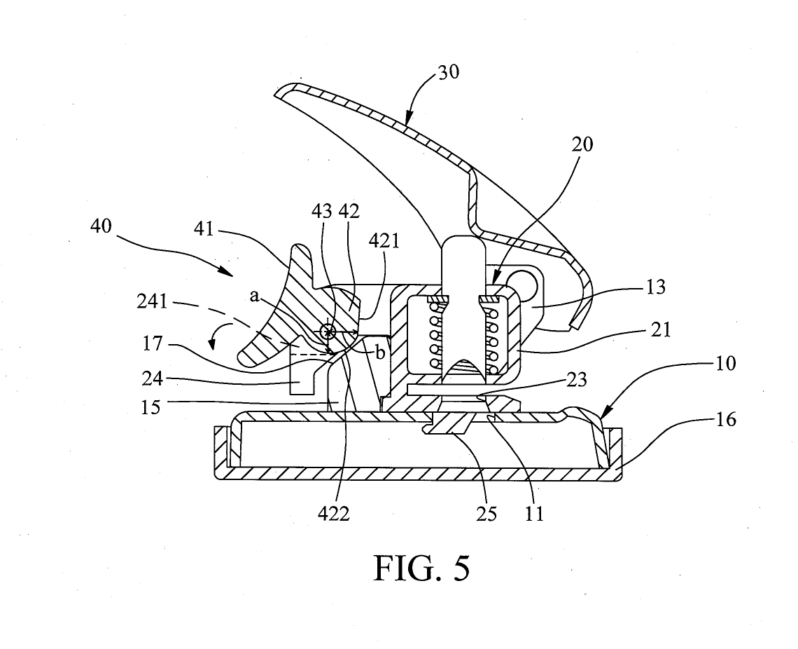

When releasing the punch seat 20, as shown in FIG. 5, by pivoting the operation board 41, the eccentric seat 42 is pivoted about the pin 43 and the first face 421 is removed from the connection side 17 and a gap is formed as mentioned, so that the punch seat 20 is freely movable along the slide board 15 to achieve the purpose of the position adjustment of the punch seat 20.

Because the second face 422 of the eccentric seat 42 is a curved face so that when pivoting the second face 422, the curved face reduces the contact area between the second face 422 and the connection side 17, the first face 421 can quickly contact the connection side 17 of the slide board 15. By the eccentric seat 42, the first face 421 properly presses the connection side 17 so that the punch seat 20 does not shift and is operated more stably.

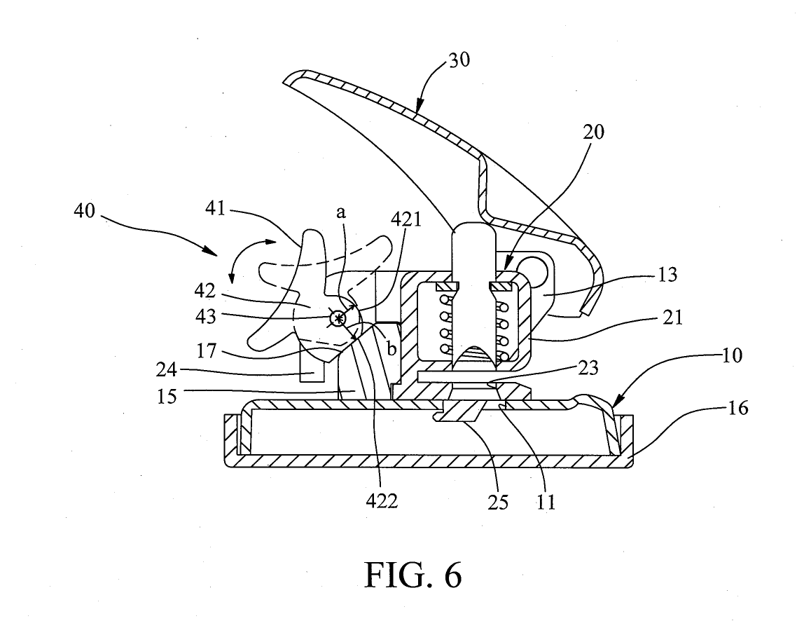

As shown in FIG. 6 which shows another embodiment of the present invention, the pin 43 is located at another position of the eccentric seat 42. When the eccentric seat 42 is operated between the positioning position and the release position for the punch seats 20, the operation directions are opposite to the directions in the first embodiment. The distance “a” between the pin 43 and the second face 422 is shorter than the distance between the pin 43 to the first face 421, the punch seat 20 is stably and slidably moved along the slide board 15.

While we have shown and described the embodiment in accordance with the present invention, it should be clear to those skilled in the art that further embodiments may be made without departing from the scope of the present invention.

What is claimed is:

1. A paper punch comprising:
a base having a hole defined in a front end thereof and an index area formed on a rear end of the base;
an elongate slide board connected to the base and located between the hole and the index area, the slide board having a connection side on an outside thereof;
multiple punch seats connected to the slide board and each punch seat being located above the hole of the base, each punch seat having a connection arm extending therefrom which is located above the index area, a passage defined through the connection arm and an opening defined in an underside of the connection arm, the slide board inserted into the opening of the connection arm;
multiple control members each having an eccentric seat and an operation board, each punch seat having a control member connected thereto, the control member connected on one side of the eccentric seat, the eccentric seat being a cam and eccentrically connected to the connection arm by a pin, a first face defined in the eccentric seat and located in opposite to the operation board, a second face being a curved face and located close to the pin, a distance from the pin to the second face being shorter than a distance from the pin to the first face, so that when switching the first face and the second face, the first face contacts the connection side of the slide board to position the punch seat to the slide board, a gap is defined between the second face and the connection side so that the punch seat is movable along the slide board.

2. The paper punch as claimed in claim 1, wherein the base has two support arms extending upward from two ends thereof, the slide board is connected between the two support arms.

3. The paper punch assembly as claimed in claim 1, wherein the connection side of the slide board is an in inclined surface.

4. The paper punch as claimed in claim 1, wherein the frame of each of the punch seats has a hook-shaped engaging end which is located corresponding to the hole of the base.

5. The paper punch as claimed in claim 4, wherein the engaging end is slidably hooked to an inside of the hole of the base.
